(19) United States
(12) Patent Application Publication
(10) Pub. No.: US 2024/0326937 A1
(43) Pub. Date: Oct. 3, 2024

(54) Transport Vehicle and Transport Facility

(71) Applicant: Daifuku Co., Ltd., Osaka-shi (JP)

(72) Inventors: Hiroki Omoto, Hinocho (JP); Shuei Seno, Hinocho (JP)

(21) Appl. No.: 18/620,247

(22) Filed: Mar. 28, 2024

(30) Foreign Application Priority Data
Mar. 31, 2023 (JP) 2023-058881

(51) Int. Cl. B62D 65/02; B60K 17/34; B60R 16/027; B62D 7/04

(52) U.S. Cl. CPC B62D 65/022; B60K 17/34; B60R 16/027; B62D 7/04

(57) ABSTRACT

A transport vehicle includes a vehicle body, a drive unit, and a coupling device coupling the vehicle body with the drive unit. The drive unit includes a wheel, a travel drive source configured to drive the wheel in such a manner as to rotate the wheel, and a steering device configured to turn the wheel around a steering axis along an up-down direction. The coupling device includes an attachment section attached to the vehicle body, and an adjustment mechanism allowing a reference direction to be changed around the steering axis relative to a front-rear direction of the vehicle body by changing an attachment orientation of the attachment section relative to the vehicle body.

### CROSS-REFERENCE TO RELATED APPLICATION

This application claims priority to Japanese Patent Application No. 2023-058881 filed Mar. 31, 2023, the disclosure of which is hereby incorporated by reference in its entirety.

### BACKGROUND OF THE INVENTION

### 1. Field of the Invention

The present invention relates to a transport vehicle and a transport facility.

### 2. Description of the Related Art

A transport vehicle is used in a factory, a distribution facility, or the like, for example, to directly transport an article or pull a truck on which an article is placed. Japanese Unexamined Patent Application Publication No. 2005-297809 (Patent Document 1) discloses an example of such a transport vehicle.

The transport vehicle (a truck tractor 100) in Patent Document 1 includes a vehicle body 1 and a drive unit (driving wheels 2, a traveling motor 5, a driving wheel rotating motor 6), and the vehicle body and the drive unit are usually coupled with each other via a coupling device in a given orientation to both the vehicle body and the drive unit.

Patent Document 1 describes a device including a motor (the driving wheel rotating motor 6) for turning wheels and a reduction gear mechanism as a steering device configured to turn the wheels (the driving wheels 2). However, depending on the specification of the transport vehicle, the maximum steering angle of the wheels may be restricted to be equal to or less than a given angle that is less than ±360°. In such a case, if the transport vehicle is moved around a circulating path at least partially having an arcuate section, for example, with the orientation of the vehicle body being maintained, the transport vehicle may be stopped in the middle of the circulating path to largely change the steering angle of the drive unit. Patent Document 1 does not mention anything about such a problem or the means for solving the problem at all.

In view of this, it is desirable to achieve a transport vehicle having an excellent transport efficiency in a case where the transport vehicle transports an article while the transport vehicle moves around a circulating path at least partially having an arcuate section with the orientation of a vehicle body being maintained, for example.

### SUMMARY OF THE INVENTION

A transport vehicle according to this disclosure is a transport vehicle including: a vehicle body; a drive unit; and a coupling device coupling the vehicle body with the drive unit. The drive unit includes: a wheel; a travel drive source configured to drive the wheel in such a manner as to rotate the wheel; and a steering device configured to turn the wheel around a steering axis along an up-down direction. The steering device is configured to turn an advancing direction within a range of ±θ° (herein, θ is a preset value less than 360) around the steering axis relative to a predetermined reference direction, the advancing direction being perpendicular to a rotation axis of the wheel as viewed vertically. The coupling device includes: an attachment section attached to the vehicle body; and an adjustment mechanism allowing the reference direction to be changed around the steering axis relative to a front-rear direction of the vehicle body by changing an attachment orientation of the attachment section relative to the vehicle body.

With this configuration, in a case where the transport vehicle moves around, for example, a circulating path at least a portion of which is an arcuate section with the orientation of the vehicle body being maintained, the adjustment mechanism is used to change the attachment orientation of the attachment section relative to the vehicle body, so that the reference direction can be inclined in advance toward a side to which the drive unit is turned during traveling in the arcuate section. Hereby, even in a case where the maximum steering angle of the drive unit (the wheel) steered by the steering device is restricted to be less than 360° on both the right side and the left side, it is possible to secure a wide range in the arcuate section where the transport vehicle can travel continuously while the steering angle of the drive unit is changed gradually. That is, it is possible to restrain the number of times of necessity to stop the transport vehicle in the middle of the arcuate section and change the steering angle of the drive unit. This accordingly makes it possible to increase transport efficiency by the transport vehicle.

Further features and advantages of the technology according to this disclosure will become clearer by the following illustrative and nonlimiting description of embodiments described with reference to the drawings.

### BRIEF DESCRIPTION OF THE DRAWINGS

FIG. 1 is a schematic diagram of a transport facility according to an embodiment;

FIG. 2 is a side view of a transport vehicle;

FIG. 3 is a bottom view of the transport vehicle;

FIG. 4 is a view illustrating a steerable range in a standard specification;

FIG. 5 is a view illustrating an electrical connection between a power supply device and a drive unit;

FIG. 6 is a view illustrating a steerable range in a case where a reference direction is perpendicular to the front-rear direction of a vehicle body; and

FIG. 7 is a schematic view illustrating an example of an adjustment mechanism.

### DESCRIPTION OF THE INVENTION

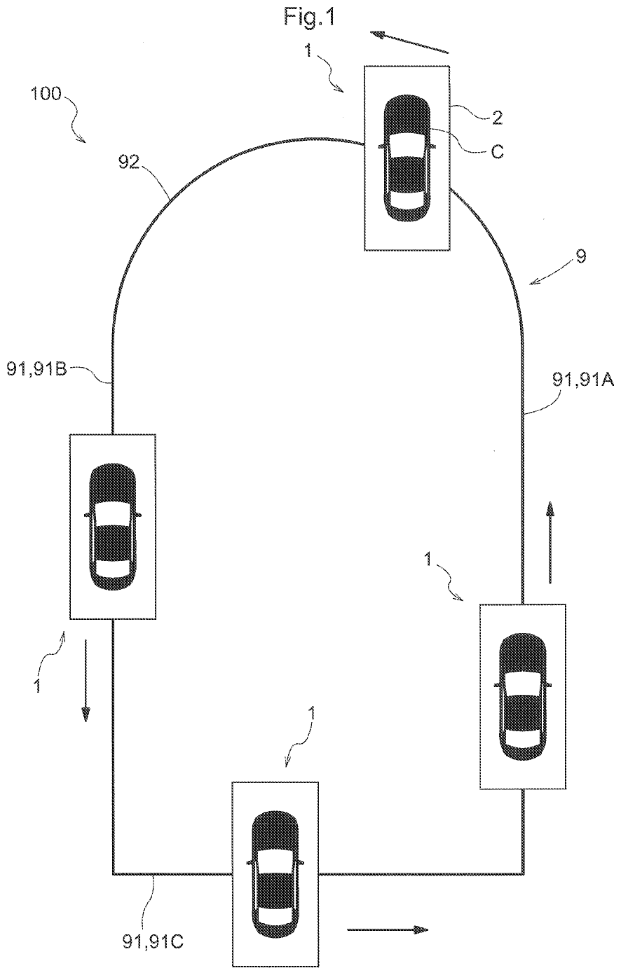

The following will describe an embodiment of a transport vehicle and a transport facility with reference to the drawings. As illustrated in FIG. 1, a transport facility 100 according to the present embodiment includes a transport vehicle 1 configured to travel along a predetermined travel path 9. The transport facility 100 includes a plurality of transport vehicles 1 configured to travel along the common travel path 9. Such a transport facility 100 is provided and used in a factory where a transport article C placed on the transport vehicle 1 is transported and assembled. As an example, the transport facility 100 can be used in an automotive manufacturing factory in which, while the transport vehicle 1 on which a vehicle body of an automobile as the transport article C is placed is moved along the travel path 9, various components are attached sequentially to the vehicle body to assemble the automobile.

The travel path 9 according to the present embodiment includes a linear section 91 and an arcuate section 92. Further, the linear section 91 includes a first linear section 91A, a second linear section 91B, and a third linear section 91C. In the present embodiment, the first linear section 91A and the second linear section 91B are disposed parallel to each other such that respective one ends are connected to each other via the arcuate section 92, and respective other ends are connected to each other via the third linear section 91C. Hereby, the travel path 9 is a circulating path at least a portion of which is the linear section 91 and the arcuate section 92 such that the first linear section 91A, the arcuate section 92, the second linear section 91B, and the third linear section 91C are connected in this order.

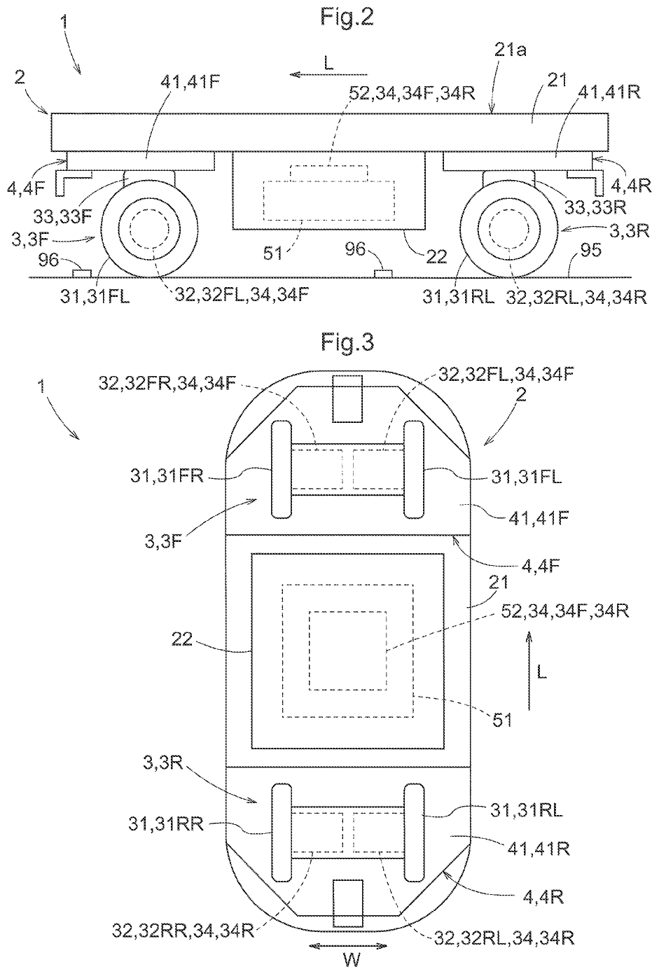

Here, the travel path 9 is a path on which the transport vehicle 1 with the transport article C (for example, a vehicle body of an automobile) being placed thereon travels. The travel path 9 is defined by a guidance member 96 (see FIG. 2) set on a travel surface 95 on which the transport vehicle 1 travels. The guidance member 96 may be physical means such as rails, for example, or may be soft means such as a magnetic marker, a light reflection tape, an electromagnetic induction cable, or a two-dimensional marker, for example. That is, the travel path 9 may be a physical path predetermined by physical means or a virtual path determined each time by soft means.

The transport vehicle 1 is guided by the guidance member 96 to move around the travel path 9. The transport vehicle 1 according to the present embodiment is provided as an unmanned transport vehicle that can perform unmanned autonomous traveling. At this time, in the present embodiment, as illustrated in FIG. 1, the transport vehicle 1 travels on the travel path 9 constituted by the circulating path with the orientation of a vehicle body 2 being maintained. Note that the expression “to maintain the orientation of the vehicle body 2” indicates that the general orientation of the vehicle body 2 is maintained and has a concept allowing a slight orientation change of the vehicle body 2 along with actual traveling of the transport vehicle 1.

As illustrated in FIGS. 2, 3, the transport vehicle 1 includes the vehicle body 2, a drive unit 3, and a coupling device 4. The transport vehicle 1 further includes a power supply device 51, a control device 52, and an electric power cable 55.

The vehicle body 2 includes a vehicle main body 21 and a storage section 22. The vehicle main body 21 is a main portion of the vehicle body 2 and serves as a general base for the transport vehicle 1. The vehicle main body 21 is formed in an oblong shape (more specifically, an oblong shape with four round corners) in a plan view. The vehicle main body 21 is also formed in an oblong shape in which a length along a front-rear direction L is longer than a length in a width direction W.

The vehicle main body 21 has an upper surface serving as a mounting surface 21a on which the transport article C is placeable. The mounting surface 21a may have a portion (for example, a peripheral edge portion) serving as a space (an entrance space) that an operator enters to perform a predetermined operation on the transport article C.

The storage section 22 is provided in a central portion of the vehicle main body 21 in the front-rear direction L in such a manner to project downward from the vehicle main body 21. The power supply device 51 and the control device 52 are stored in the storage section 22. The power supply device 51 and the control device 52 are provided at a position near the central portion of the vehicle body 2 and closer to the travel surface 95 than the vehicle main body 21.

The drive unit 3 includes a wheel 31, a travel drive source 32, a support 33, and a steering device 34. In the present embodiment, the drive unit 3 includes a pair of wheels 31, a pair of travel drive sources 32 corresponding to the pair of wheels 31, the support 33, and the steering device 34. Further, two drive units 3 each configured as such are provided such that the two drive units 3 are disposed separately from each other in the front-rear direction L of the vehicle body 2.

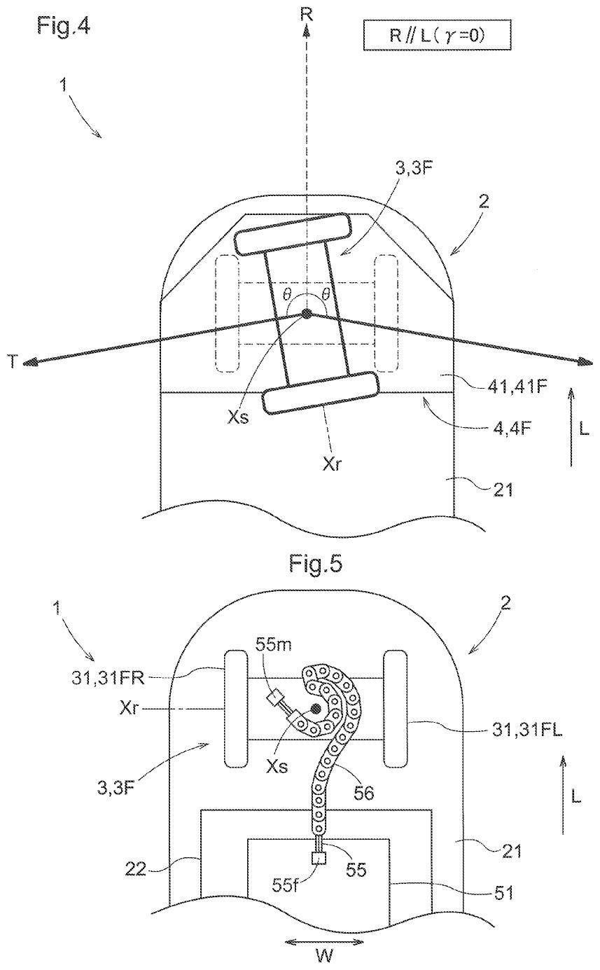

The wheels 31 rotate around a rotation axis Xr. The wheels 31 according to the present embodiment are both driving wheels connected to the travel drive sources 32. The wheels 31 are driven by the travel drive sources 32 to produce a thrust in an advancing direction T (see FIG. 4) that is a direction perpendicular to the rotation axis Xr.

The travel drive sources 32 are connected to the wheels 31 to transmit a driving force thereto. The travel drive sources 32 may be connected to the wheels 31 to rotate together in an integrated manner or may be connected to the wheels 31 via a transmission (for example, a speed reducer). In either case, the travel drive sources 32 drive the wheels 31 by the driving force in such a manner as to rotate the wheels 31. In the present embodiment, one travel drive source 32 is connected to one wheel 31 to transmit a driving force thereto. The travel drive source 32 is an electric motor, for example.

The support 33 supports, to the vehicle body 2, the wheel 31 and the travel drive source 32 connected to each other in a driving-force transmittable manner. The support 33 according to the present embodiment commonly supports the pair of wheels 31 coaxial with each other. The support 33 is disposed between the pair of wheels 31 and extends along a steering axis Xs along the up-down direction.

The steering device 34 turns the wheels 31 around the steering axis Xs along the up-down direction. The steering device 34 according to the present embodiment collectively turns the pair of wheels 31 coaxial with each other, around the steering axis Xs. As illustrated in FIG. 4, the steering device 34 can turn the advancing direction T within a range of ±θ° around the steering axis Xs relative to a predetermined reference direction R, the advancing direction T being perpendicular to the rotation axis Xr of the wheels 31 as viewed vertically. Here, θ is a preset value less than 360. FIG. 4 illustrates a case where θ is set to a value slight larger than 90.

Further, in the example of FIG. 4, the front-rear direction L of the vehicle body 2 is taken as the reference direction R based on a general specification. Note that, in the present example, γ=0 is satisfied, where γ° is defined as an angle formed between the reference direction R and the front-rear direction L of the vehicle body 2. In such a configuration, when the steering device 34 turns the wheels 31 around the steering axis Xs, the steering angle of the drive unit 3 can be changed to both the right side and the left side within θ°.

The steering device 34 is not limited to specific means, provided that the steering device 34 can turn the wheels 31 around the steering axis Xs. The steering device 34 may be constituted by tangible means (for example, a power transmission mechanism) including a steering drive source (for example, a steering motor) and a transmission mechanism (for example, a gear mechanism or a link mechanism) or may be constituted by intangible means including a control on the pair of wheels 31.

The present embodiment employs the latter configuration. More specifically, the pair of wheels 31 have different rotation speeds, and they are turned around the steering axis Xs. In this case, the steering device 34 is constituted by a rotation speed control on the wheels 31 which rotation speed control is performed in collaboration of the control device 52 and the travel drive source 32.

As illustrated in FIGS. 2, 3, the drive unit 3 is coupled with the vehicle body 2 via the coupling device 4 (described later). In the present embodiment, two coupling devices 4 are provided such that the two coupling devices 4 are disposed separately from each other in the front-rear direction L of the vehicle body 2. In the present embodiment, the coupling device 4 provided on the front side in the front-rear direction L is referred to as a “front coupling device 4F,” and the coupling device 4 provided on the rear side in the front-rear direction L is referred to as a “rear coupling device 4R.” The front coupling device 4F and the rear coupling device 4R are disposed opposite to each other across the power supply device 51 and the control device 52 sandwiched therebetween in the front-rear direction L.

As described above, in the present embodiment, the two drive units 3 are disposed separately from each other in the front-rear direction L of the vehicle body 2. In the present embodiment, the drive unit 3 on the front side in the front-rear direction L is referred to as a “front-wheel unit 3F,” and the drive unit 3 on the rear side in the front-rear direction L is referred to as a “rear-wheel unit 3R.” The front-wheel unit 3F and the rear-wheel unit 3R are disposed opposite to each other across the power supply device 51 and the control device 52 sandwiched therebetween in the front-rear direction L.

The front-wheel unit 3F includes a right front wheel 31FR and a left front wheel 31FL coaxial with each other as the wheels 31. The front-wheel unit 3F further includes, as the travel drive sources 32, a right-front-wheel travel drive source 32FR coupled with the right front wheel 31FR and a left-front-wheel travel drive source 32FL coupled with the left front wheel 31FL. The front-wheel unit 3F further includes, as the support 33, a front-wheel support 33F commonly supporting the right front wheel 31FR and the left front wheel 31FL. The front-wheel unit 3F also includes, as the steering device 34, a front-wheel steering device 34F configured to turn the right front wheel 31FR and the left front wheel 31FL around the steering axis Xs. The front-wheel unit 3F is coupled with the vehicle body 2 via the front coupling device 4F.

The rear-wheel unit 3R includes a right rear wheel 31RR and a left rear wheel 31RL coaxial with each other as the wheels 31. The rear-wheel unit 3R further includes, as the travel drive sources 32, a right-rear-wheel travel drive source 32RR coupled with the right rear wheel 31RR and a left-rear-wheel travel drive source 32RL coupled with the left rear wheel 31RL. The rear-wheel unit 3R further includes, as the support 33, a rear-wheel support 33R commonly supporting the right rear wheel 31RR and the left rear wheel 31RL. The rear-wheel unit 3R further includes, as the steering device 34, a rear-wheel steering device 34R configured to turn the right rear wheel 31RR and the left rear wheel 31RL around the steering axis Xs. The rear-wheel unit 3R is coupled with the vehicle body 2 via the rear coupling device 4R.

The power supply device 51 supplies electric power to drive the transport vehicle 1. The power supply device 51 supplies electric power to at least the travel drive sources 32 and the control device 52. In addition to that, the power supply device 51 may supply electric power to other components such as various sensors provided in various portions of the vehicle body 2, for example. The power supply device 51 usable herein is a secondary battery such as a lithium ion battery, an electrolytic capacitor, an electric double layer capacitor, or the like, for example.

The control device 52 mainly controls the travel drive source 32. The control device 52 includes, for example, a driver unit including a driver circuit including a semiconductor element, and a control substrate for controlling the operation of the semiconductor element included in the driver unit, for example. In response to a command received from a host controller (not illustrated) (a superior control device controlling the whole transport facility 100), the control device 52 executes a drive control on the travel drive source 32 such that the transport vehicle 1 travels along the travel path 9.

The power supply device 51 and the control device 52 are attached to the central portion of the vehicle body 2 in the front-rear direction L. The power supply device 51 and the control device 52 are provided in the storage section 22 provided in the central portion of the vehicle body 2 in the front-rear direction L. FIGS. 2, 3 illustrates a configuration in which the power supply device 51 and the control device 52 are stacked vertically, but they may be arranged along the front-rear direction L.

As illustrated in FIG. 5, the electric power cable 55 electrically connects the power supply device 51 to the drive unit 3. Note that FIG. 5 is a plan view focusing on an arrangement configuration below the vehicle main body 21, and FIG. 5 illustrates only an external shape of the vehicle main body 21 and omits the coupling device 4. The electric power cable 55 electrically connects the power supply device 51 fixed to the vehicle body 2 to the drive unit 3 supported on the vehicle body 2 to be turnable around the steering axis Xs. The electric power cable 55 includes a fixed connecting section 55f in one end portion and a movable connecting section 55m in the other end portion. The electric power cable 55 is connected to the power supply device 51 via the fixed connecting section 55f and is connected to the drive unit 3 via the movable connecting section 55m.

Here, the fixed connecting section 55f is connected to the power supply device 51 such that the position of the fixed connecting section 55f relative to the vehicle body 2 is unchangeable. Meanwhile, the movable connecting section 55m is connected to the drive unit 3 and turns together with the wheels 31 to be steered. The position of the movable connecting section 55m in a plan view is changeable in response to turning of the drive unit 3. The shape of the electric power cable 55 in a plan view is also changeable in response to the position of the movable connecting section 55m. On this account, the electric power cable 55 is disposed to be stored in a protective cover 56 having a chain form with a changeable external shape.

Note that it is also conceivable to electrically connect the power supply device 51 to the drive unit 3 by use of a rotary connector, a slip ring, or the like. The use of the rotary connector, the slip ring, or the like is preferable in that the drive unit 3 can be freely turned by 360°. However, in a case where such means is used, electric power to drive the drive unit 3 is restricted to be less than relatively small limit electric power. For this reason, instead of using the rotary connector or the slip ring, it is necessary to use the electric power cable 55 corresponding to large electric power for the transport vehicle 1 configured to transport heavy goods such as a vehicle body of an automobile as the transport article C, for example, like the present embodiment.

When the electric power cable 55 is used, it is possible to handle large electric power. In the meantime, as described above, the maximum steering angle at the time when the steering device 34 turns the wheels 31 around the steering axis Xs is restricted to θ° on both the right side and the left side (see FIG. 4). Because of such a restriction, in a case where the transport vehicle 1 travels on the travel path 9 constituted by the circulating path as illustrated in FIG. 1, at the time when the drive unit 3 turns left to the maximum steering angle, it is necessary to stop the transport vehicle 1 once and reset the orientation of the drive unit 3.

In this respect, in the case of the transport vehicle 1 according to the present embodiment, by partially modifying the coupling device 4 provided to connect the vehicle body 2 to the drive unit 3, the number of necessary times to stop the transport vehicle 1 in the middle and reset the orientation of the drive unit 3 is reduced.

As illustrated in FIGS. 2, 3, the coupling device 4 includes an attachment section 41 attached to the vehicle body 2. For example, the attachment section 41 is made of a plate-shaped member and is fixed to the lower surface of the vehicle main body 21. In a plan view, the attachment section 41 is formed in a deformed home-base shape with its end being cut or in a deformed trapezoidal shape obtained by combining a trapezoidal shape and a rectangular shape. The drive unit 3 is attached to the attachment section 41 via the support 33.

As described above, in the present embodiment, the coupling device 4 includes the front coupling device 4F and the rear coupling device 4R such that the front coupling device 4F includes a front attachment section 41F, and the rear coupling device 4R includes a rear attachment section 41R. The front-wheel unit 3F is attached to the front attachment section 41F via the front-wheel support 33F, and the rear-wheel unit 3R is attached to the rear attachment section 41R via the rear-wheel support 33R.

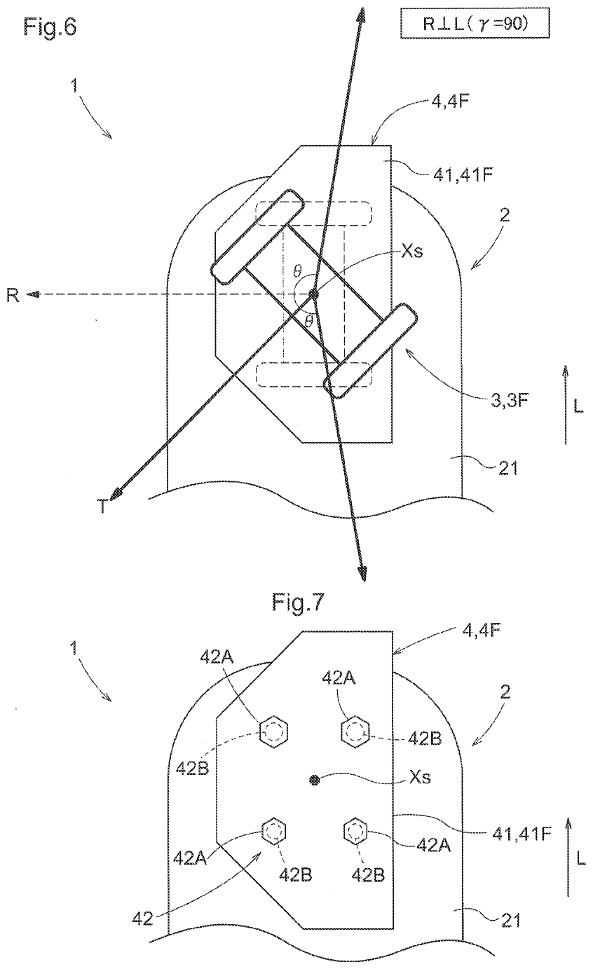

The coupling device 4 further includes an adjustment mechanism 42 that can change the reference direction R around the steering axis Xs relative to the front-rear direction L of the vehicle body 2 by changing an attachment orientation of the attachment section 41 relative to the vehicle body 2. When the coupling device 4 includes the adjustment mechanism 42, the orientation of the attachment section 41 having a deformed home base shape or a deformed trapezoidal shape is changeable while the position of the steering axis Xs relative to the vehicle body 2 is unchangeable, as well understood from a comparison between FIG. 4 and FIG. 6. In response to that, the reference direction R of the drive unit 3 relative to the front-rear direction L of the vehicle body 2 is changeable.

The adjustment mechanism 42 can change the reference direction R within γ° relative to the front-rear direction L of the vehicle body 2. Here, the magnitude of γ is not limited particularly (as long as the reference direction R can be changed slightly), but in a case where θ is set to a value larger than 90 (and also a value less than 180) like the present embodiment, it is preferable that γ be set to a value equal to or more than 90 in advance. Further, it is preferable that γ be set to a multiple of 90 (i.e., 90, 180, or 270). In the example of FIG. 6, the adjustment mechanism 42 changes the reference direction R to the left by 90° relative to the front-rear direction L of the vehicle body 2. Hereby, the angle γ° formed between the reference direction R and the front-rear direction L of the vehicle body 2 is 90°.

The following gives a further description with reference to the example in FIG. 6. The drive unit 3 is turnable within ±θ° around the steering axis Xs relative to the reference direction R the orientation of which is changed to the left by 90° relative to the front-rear direction L of the vehicle body 2. In the present embodiment, θ is set to a value slightly larger than 90° as described above. Accordingly, in the transport facility 100 in FIG. 1, for example, the transport vehicle 1 is allowed to travel in the first linear section 91A with the advancing direction T of the drive unit 3 is changed to the right by 90° relative to the reference direction R.

When the transport vehicle 1 comes in the arcuate section 92, the steering angle of the drive unit 3 can be gradually changed such that the advancing direction T faces the tangential direction of the arcuate section 92 in accordance with the position of the transport vehicle 1. As understood from FIG. 6, the advancing direction T can be continuously changed without interruption in the middle from a state where the advancing direction T has an orientation changed to the right by 90° relative to the reference direction R to a state where the advancing direction T has an orientation changed to the left by 90° relative to the reference direction R. This allows the transport vehicle 1 to travel continuously from the first linear section 91A to the second linear section 91B via the arcuate section 92.

Note that, at the time of transition from the second linear section 91B to the third linear section 91C or at the time of transition from the third linear section 91C to the first linear section 91A again, it is necessary to reset the orientation of the drive unit 3. Even so, in view of the whole travel path 9 constituted by the circulating path, a distance where the transport vehicle 1 can travel continuously is secured long (in other words, the number of times to stop the transport vehicle 1 is reduced), and the transport efficiency by the transport vehicle 1 is improved.

As illustrated in FIG. 7, the adjustment mechanism 42 according to the present embodiment includes a through-hole 42B formed to penetrate through the attachment section 41 in its thickness direction, and a fixing bolt 42A passed through the through-hole 42B to be fastened and fixed to the vehicle main body 21. The vehicle main body 21 includes a threaded engagement hole with which the fixing bolt 42A is fastened, and the threaded engagement hole also serves as part of the adjustment mechanism 42. Thus, the adjustment mechanism 42 may be partially provided in the vehicle main body 21.

In the present embodiment, four through-holes 42B are formed at vertical positions of a square around the position of the steering axis Xs. This makes it possible to easily change the reference direction R by a unit of 90°.

### Other Embodiments

(1) The above embodiment has described an example in which the adjustment mechanism 42 can change the reference direction R by a unit of 90° relative to the front-rear direction L of the vehicle body 2. However, the present invention is not limited to such a configuration, and the adjustment mechanism 42 may change the reference direction R by a predetermined angle unit such as 45°, 22.5°, or 60° relative to the front-rear direction L of the vehicle body 2, for example. Alternatively, the adjustment mechanism 42 may change the angle of the reference direction R linearly relative to the front-rear direction L of the vehicle body 2.

(2) The above embodiment has been described on the presumption that the adjustment mechanism 42 can change the reference direction R relative to the front-rear direction L of the vehicle body 2 only during the stop of the transport vehicle 1. However, the present invention is not limited to such a configuration, and the adjustment mechanism 42 may change the reference direction R relative to the front-rear direction L of the vehicle body 2 automatically during the traveling of the transport vehicle 1, for example. Such a configuration may include, for example, a drive source for adjustment (for example, an adjustment motor) and a transmission mechanism (for example, a gear mechanism or a link mechanism).

(3) In the above embodiment, the transport vehicle 1 may further include notification means for notifying the control device 52 of the change of the reference direction R when the reference direction R has been changed. The notification means usable herein is a physical mechanism such as a toggle switch or a knob, for example. In this case, when an operator performs an operation to change the orientation of the adjustment mechanism 42, the operator may operate the notification means as well. Alternatively, the notification means may be a transmitter or the like for transmitting a signal indicating that the reference direction R has been changed. The change signal of the reference direction R may be notified directly from an interface provided in the transport vehicle 1 or may be notified indirectly via the host controller or the like.

(4) In the above embodiment, the transport vehicle 1 may further include a rotation angle sensor for detecting the orientation of each drive unit 3. The rotation angle sensor may be configured to always take the front-rear direction L of the vehicle body 2 as an absolute reference. In this case, by turning each drive unit 3 to its limit on the right or left side at the time of starting of the transport vehicle 1, for example, the control device 52 can grasp the reference direction R of each drive unit 3 based on a detected movable range.

(5) In the above embodiment, the transport vehicle 1 may further include a controlling cable (including a controlling signal line, a sensor wiring line, or the like) connecting the control device 52 to the drive unit 3. In this case, the controlling cable may be stored in the protective cover 56 together with the electric power cable 55. Further, the transport vehicle 1 may further include various sensor groups such as an obstacle sensor for detecting the presence of an obstacle, for example. In this case, the transport vehicle 1 may further include a detection cable (including a sensor wiring line or the like) connecting various sensors to the control device 52, and the detection cable may be stored in the protective cover 56 together with the electric power cable 55.

(6) The above embodiment has described, as an example, the configuration in which the electric power cable 55 is disposed to be stored in the protective cover 56. However, the present invention is not limited to such a configuration, and the electric power cable 55 may be disposed without any protection.

(7) The above embodiment has described on the presumption that the steering axis Xs as a turning axis for the wheels 31 turned by the steering device 34 is along the vertical direction. However, the present invention is not limited to such a configuration, and the steering axis Xs may be slightly inclined from the vertical direction (for example, by an inclination angle within 10° from the vertical direction). Such a state where the steering axis Xs is disposed to be slightly inclined from the vertical direction is also included in the concept “along the up-down direction.”

(8) The above embodiment has described, as an example, the configuration in which four wheels 31 are provided for one transport vehicle 1. However, the present invention is not limited to such a configuration, and the number of wheels 31 per one transport vehicle 1 may be three or may be five or more, for example. Some of the plurality of wheels 31 may not be driving wheels coupled with the travel drive sources 32 and may be auxiliary wheels that just rotate freely.

(9) The above embodiment has described, as an example, the configuration in which the arcuate section 92 included in the travel path 9 is formed in a shape corresponding to part of a circular arc of a perfect circle (more specifically, a semicircle). However, the present invention is not limited to such a configuration, and the arcuate section 92 may have a shape including a linear shape in its intermediate portion or may be a shape having a curvature changing by location, for example.

(10) The above embodiment has described, as an example, the configuration in which the transport vehicle 1 is an unmanned transport vehicle that can perform unmanned autonomous traveling. However, the present invention is not limited to such a configuration, and the transport vehicle 1 may be a manned transport vehicle (for example, a forklift or the like) that a person drives.

(11) The configurations described in the embodiments (the above embodiment and other embodiments; the same applies hereinafter) can be applied in combination with configurations described in other embodiments as long as no inconsistency occurs. In terms of the other configurations, the embodiments disclosed in the present specification are just examples in all respects, and various modifications can be made within a range that does not deviate from the gist of this disclosure.

### Overview of Embodiment

When the above descriptions are summarized, the transport vehicle according to this disclosure preferably has the following configurations.

A transport vehicle includes a vehicle body, a drive unit, and a coupling device coupling the vehicle body with the drive unit. The drive unit includes: a wheel; a travel drive source configured to drive the wheel in such a manner as to rotate the wheel; and a steering device configured to turn the wheel around a steering axis along an up-down direction. The steering device is configured to turn an advancing direction within a range of ±θ° (herein, θ is a preset value less than 360) around the steering axis relative to a predetermined reference direction, the advancing direction being perpendicular to a rotation axis of the wheel as viewed vertically. The coupling device includes: an attachment section attached to the vehicle body; and an adjustment mechanism allowing the reference direction to be changed around the steering axis relative to a front-rear direction of the vehicle body by changing an attachment orientation of the attachment section relative to the vehicle body.

With this configuration, in a case where the transport vehicle moves around, for example, a circulating path at least a portion of which is an arcuate section with the orientation of the vehicle body being maintained, the adjustment mechanism is used to change the attachment orientation of the attachment section relative to the vehicle body, so that the reference direction can be inclined in advance toward a side to which the drive unit is turned during traveling in the arcuate section. Hereby, even in a case where the maximum steering angle of the drive unit (the wheel) steered by the steering device is restricted to be less than 360° on both the right side and the left side, it is possible to secure a wide range in the arcuate section where the transport vehicle can travel continuously while the steering angle of the drive unit is changed gradually. That is, it is possible to restrain the number of times of necessity to stop the transport vehicle in the middle of the arcuate section and change the steering angle of the drive unit. This accordingly makes it possible to increase transport efficiency by the transport vehicle.

As one aspect, it is preferable that the adjustment mechanism allow the reference direction to be changed within γ° (herein, γ is a preset value equal to or more than θ) relative to the front-rear direction of the vehicle body.

With this configuration, in the aforementioned case, for example, the adjustment mechanism is used to incline the reference direction in advance by the maximum steering angle toward the side to which the drive unit is turned during traveling in the arcuate section. Hereby, it is possible to secure, to the maximum corresponding to the maximum steering angle, a wide range in the arcuate section where the transport vehicle can travel continuously while the orientation of the drive unit is changed gradually.

As one aspect, it is preferable that the adjustment mechanism allow the reference direction to be changed by a unit of 90° within γ° (herein, γ is a preset value equal to or more than 90, and θ is a preset value equal to or more than 90 but less than 180) relative to the front-rear direction of the vehicle body.

With this configuration, in the aforementioned case, for example, when the adjustment mechanism is used to incline the reference direction in advance by 90° toward the side to which the drive unit is turned during traveling in the arcuate section, the transport vehicle can continuously travel half around the arcuate section while the orientation of the drive unit is changed gradually. Further, since the adjustment mechanism changes the reference direction by a unit of 90°, it is possible to simplify the configuration of the adjustment mechanism.

As one aspect, it is preferable that: the transport vehicle include a power supply device attached to the vehicle body, and an electric power cable electrically connecting the power supply device to the drive unit; and the electric power cable include a fixed connecting section connected to the power supply device and unchangeable in position relative to the vehicle body, and a movable connecting section connected to the drive unit and configured to turn together with the wheel steered.

With this configuration, even in a case where electric power for driving the drive unit is large, the electric power cable can electrically connect the power supply device to the drive unit appropriately. On the other hand, when the electric power cable is used, the maximum steering angle of the drive unit (the wheel) is restricted. However, since the transport vehicle includes the adjustment mechanism as described above, it is possible to secure a wide range in the arcuate section where the transport vehicle can travel continuously while the orientation of the drive unit is changed gradually.

As one aspect, it is preferable that: the drive unit include a front-wheel unit and a rear-wheel unit; the coupling device include a front coupling device and a rear coupling device; the front-wheel unit include, as the wheel, a right front wheel and a left front wheel coaxial with each other, and be coupled with the vehicle body via the front coupling device; and the rear-wheel unit include, as the wheel, a right rear wheel and a left rear wheel coaxial with each other, and be coupled with the vehicle body via the rear coupling device.

With this configuration, the transport vehicle can travel stably with four or more wheels including at least the right front wheel, the left front wheel, the right rear wheel, and the left rear wheel.

Further, the transport facility according to this disclosure preferably has the following configurations.

A transport facility includes a transport vehicle with the above configurations which transport vehicle travels along a predetermined travel path. The travel path is a circulating path at least a portion of which is an arcuate section, and the transport vehicle is configured to travel on the circulating path with the vehicle body maintaining an orientation.

Like this configuration, the transport vehicle described above can be preferably applied to the transport facility that causes the transport vehicle to move around the circulating path at least a portion of which is the arcuate section with the orientation of the vehicle body being maintained.

As one aspect, it is preferable that: the travel path be defined by a guidance member set on a travel surface on which the transport vehicle travels; and the transport vehicle be guided by the guidance member to travel.

With this configuration, the transport vehicle can travel appropriately along the travel path provided with the guidance member. In addition, in a case where a feedback control is performed such that the transport vehicle travels along the guidance member, for example, the transport vehicle does not need to recognize an origin position of a steering angle. Thus, even when the angle of the reference direction is adjusted by the adjustment mechanism, it is possible to reduce time to change control setting.

The transport vehicle and the transport facility according to this disclosure should be able to achieve at least one of the above effects.

What is claimed is:

1. A transport vehicle, comprising:
a vehicle body;
a drive unit; and
a coupling device coupling the vehicle body with the drive unit,
wherein the drive unit comprises:
a wheel;
a travel drive source configured to drive the wheel in such a manner as to rotate the wheel; and
a steering device configured to turn the wheel around a steering axis along an up-down direction,
wherein the steering device is configured to turn an advancing direction within a range of ±θ° (herein, θ is a preset value less than 360) around the steering axis relative to a predetermined reference direction, the advancing direction being perpendicular to a rotation axis of the wheel as viewed vertically, and
wherein the coupling device comprises:
an attachment section attached to the vehicle body; and
an adjustment mechanism allowing the reference direction to be changed around the steering axis relative to a front-rear direction of the vehicle body by changing an attachment orientation of the attachment section relative to the vehicle body.

2. The transport vehicle according to claim 1, wherein:
the adjustment mechanism allows the reference direction to be changed within γ° (herein, γ is a preset value equal to or more than θ) relative to the front-rear direction of the vehicle body.

3. The transport vehicle according to claim 1, wherein:
the adjustment mechanism allows the reference direction to be changed by a unit of 90° within γ° (herein, γ is a preset value equal to or more than 90, and θ is a preset value equal to or more than 9° but less than 180) relative to the front-rear direction of the vehicle body.

4. The transport vehicle according to claim 1, further comprising:
a power supply device attached to the vehicle body; and
an electric power cable electrically connecting the power supply device to the drive unit, and
wherein the electric power cable comprises:
a fixed connecting section connected to the power supply device and unchangeable in position relative to the vehicle body; and
a movable connecting section connected to the drive unit and configured to turn together with the wheel steered.

5. The transport vehicle according to claim 1, wherein:
the drive unit comprises a front-wheel unit and a rear-wheel unit,
the coupling device comprises a front coupling device and a rear coupling device,
the front-wheel unit comprises, as the wheel, a right front wheel and a left front wheel coaxial with each other, and is coupled with the vehicle body via the front coupling device, and
the rear-wheel unit comprises, as the wheel, a right rear wheel and a left rear wheel coaxial with each other, and is coupled with the vehicle body via the rear coupling device.

6. A transport facility, further comprising:
the transport vehicle according to claim 1 which transport vehicle travels along a predetermined travel path,
wherein the travel path is a circulating path at least a portion of which is an arcuate section, and
wherein the transport vehicle is configured to travel on the circulating path with the vehicle body maintaining an orientation.

7. The transport facility according to claim 6, wherein:
the travel path is defined by a guidance member set on a travel surface on which the transport vehicle travels, and
the transport vehicle is guided by the guidance member to travel.
